(19) United States
(12) Patent Application Publication
(10) Pub. No.: US 2011/0045204 A1
(43) Pub. Date: Feb. 24, 2011

(54) COATING PROCESS AND COATED PRODUCTS

(75) Inventors: Peter Kenneth John Robertson, Aberdeen (GB); Patricia Mary Pollard, Aberdeen (GB); Simon Officer, Aberdeen (GB); Jeanette Mary Claire Robertson, Aberdeen (GB)

Correspondence Address: WINSTEAD PC, P.O. BOX 50784, DALLAS, TX, 75201, US

(73) Assignee: THE ROBERT GORDON UNIVERSITY, Aberdeen (GB)

(21) Appl. No.: 12/918,087

(22) PCT Filed: Feb. 17, 2009
(86) PCT No.: PCT/GB2009/000425

§ 371 Date: Nov. 12, 2010

(30) Foreign Application Priority Data
Feb. 18, 2008 (GB) 0802927.4

(51) Int. Cl. B05D 5/00; C09D 5/14

(52) U.S. Cl. 427/553; 106/15.05

(57) ABSTRACT

A surface treatment material useful in making coatings to be applied to fomitic surfaces to inhibit the proliferation of microorganisms, especially bacteria, comprises a photocatalytic component consisting of a metal oxide catalyst together with a metal dopant acting as an upconversion luminescence agent, for example based upon ErCl₃, TiO₂, Er(NO₃)₃/TiO₂, NdCl₃/TiO₂, Nd(NO₃)₃/TiO₂, GdCl₃/TiO₂, Gd(NO₃)/TiO₂, and optionally including other metals, especially a transition metal such as silver, provides antimicrobial activity in the dark, and enhanced antibacterial activity when exposed to wavelengths in the range of 350 to 790 nm, and thus finds utility in the healthcare, leisure and food industries.

This invention relates to coating processes and coatings to be applied to fomitic surfaces to inhibit the proliferation of microorganisms, and thus is applicable in healthcare, leisure and food industries for example.

### BACKGROUND TO THE INVENTION

Infection by a pathogenic microorganism represents one of the highest risks to human health and yet people are often more concerned about injury at work or in a road traffic incident. The lack of awareness of the true risks means that people are often careless about hygiene and generally ill informed about precautions that would mitigate the risks of infection. Therefore, the burden for control of infection has generally fallen to healthcare professionals and the result of this approach often lies with combative strategies involving a post-infection treatment rather than a preventative measure. Whilst prophylactic measures such as vaccination are generally well organised this strategy again lies within the remit of the healthcare professional which undoubtedly places undue burden upon a small percentage of the population.

An alternative strategy that would inhibit infection by reducing exposure to infection is a desirable objective. However, current (2007) media coverage of hospital patients acquiring infection by antibiotic-resistant strains of microorganisms suggests that a suitable alternative strategy has yet to be discovered.

Salmonella spp. and Campylobacter spp. are the two most common causes of “food poisoning” throughout most of Europe with more than 160,000 and 120,000 reported cases, respectively, in EU countries (data reported in 1999). It has been reported that in the Netherlands 1400 hours of work are lost annually to disability as a result of Campylobacter-related ill health. This represents a significant burden of potentially avoidable diseases related to food-borne infections with social and economic consequences for communities and their health care systems.

An infectious intestinal diseases study in England estimated that there were 4.5 million cases annually with an associated cost estimated at some Euro 1.7 billion per year.

Health professionals recognise that many infections arise from contact with an infected surface, i.e. a fomitic surface. A fomite is “an inanimate object or substance, such as clothing, furniture, or soap, that is capable of transmitting infectious organisms from one individual to another” (The American Heritage® Medical Dictionary 2004-2007, Houghton Mifflin Company). Thus, fomites can be macroscopic surfaces, or they can be loose particles such as grains of dust, fibers, dirt, hair, and skin cells, which may at times be suspended in the air but most often settle on macroscopic surfaces. Fomitic surfaces may be passive reservoirs (receiving a load of contaminants that gradually dies away over time) or active participants, supporting the growth and spread of disease-inducing organisms. Counter-intuitively, it has been found that smooth (non-porous) surfaces promote the spread of bacteria and viruses by contact better than porous materials. This is due to the ease of transfer therefrom, whereas porous materials have a greater chance of entrapping a micro-organism so that transfer is less likely.

Almost any surface, including glassware, and stainless steel which is favoured for food-preparation, can serve as a fomitic reservoir, but the public is generally poorly aware of any risk that is not visible to the naked eye. Most health professionals suspect or consider that many patients presenting with symptoms of such infections acquired the infection from contamination of surfaces where food was prepared. The situation may be aggravated by the suspicion that most food industry workers are not highly educated nor adequately informed about appropriate hygiene precautions for food preparation.

Whereas use of a disinfecting agent is popular, it is often difficult to ensure that adequate surface treatment is applied, and its efficacy is likely to be of relatively short duration due to wipe-off, wash-off, evaporation to dryness, chemical degradation of the effective agent, acquired resistance in the microbial population, and the like factors. Furthermore, it may be particularly challenging to combat a microorganism that adopts a biofilm strategy by way of traditional approaches.

### SUMMARY OF THE INVENTION

Accordingly it is an object of this invention to focus on the surface contamination problem and to provide a means for obviating or mitigating risks of infection by treating a fomitic surface to confer advantageous properties thereon.

The above object is achievable by providing a coating for a fomitic surface that comprises a photocatalytic component in an antibacterial effective amount.

The coating may be prepared by a wet chemistry method to provide a coating fluid that can be adopted as a surface treatment material.

The photocatalytic component may comprise a metal oxide catalyst together with a metal dopant acting as an upconversion luminescence agent.

The presence of the dopant enhances the photocatalytic properties of the photocatalytic component. In particular, the doped coating responds to visible light and exhibits antibacterial effects.

The metal oxide may be a titanium oxide, and the metal dopant may comprise at least one of a transition metal, a rare earth, or heavy metal. Said metal dopant may be introduced as a salt, complex or compound conferring the desired upconversion luminescence properties in the prepared photocatalytic component.

Hitherto, antibacterial effects of titania have been observed under stimulation by UV light, but the invention described here extends activity in terms of at least antibacterial effects to illumination by visible light.

The surface treatment material may also include silver in a form suitable to perform an antimicrobial function, e.g. as a nanoparticle or salt.

The surface treatment material may include a surface active agent or vehicle, to improve flow characteristics, such as a solvent, dispersant, extender or diluent to improve processing and application characteristics to promote full coverage of a surface to be treated.

A poly(ethylene glycol) (PEG), also known as poly(ethylene oxide) (PEO) or polyoxyethylene (POE), may be suitable for use in the surface treatment material to vary consistency.

Thus according to one aspect of the invention there is provided a surface treatment material for a fomitic surface that comprises a photocatalytic component in an amount effective to provide antibacterial effects under optical stimulation, wherein the photocatalytic component comprises a metal oxide catalyst together with a metal dopant acting as an upconversion luminescence agent.

The surface treatment material may essentially consist of a crystalline photocatalytic metal oxide together with a metal dopant acting as an upconversion luminescence agent.

The surface treatment material may comprise a titanium oxide, and at least one of a transition metal, a rare earth, or heavy metal.

The surface treatment material may comprise a metal salt, metal complex or metal compound conferring the desired upconversion luminescence properties in the prepared photocatalytic component.

Exposure to UV-visible light stimulates an excitation event or photocatalysis function that has an enhanced effect with regard to killing of bacterial cells in comparison with photolysis demonstrable with bacterial cell exposure to UV alone. An advantage of the invention is that effects are obtainable by exposure of the treated surface to visible light, allowing natural daylight to be utilised.

The surface treatment material may additionally comprise silver in a form suitable to perform an antimicrobial function, preferably as a nanoparticle, but optionally as a salt. Presence of silver also enhances antibacterial effects of the photocatalytic components. Silver also has an effect without requiring optical stimulation, so that an effect is evident even in the dark.

The silver may be present as a nanoparticle or salt, preferably the former.

The surface treatment material may be applied as a coating composition and fixed to a surface in a suitable manner, e.g. drying sufficiently and annealing.

A laser is suitable for achieving this purpose because effects thereof are confined to surface effects with little impact upon the bulk material underneath the surface.

A surface treatment material adapted for use in treating a fomitic surface may comprise a polyethylene glycol.

According to another aspect of the invention, there is provided a treatment process for a fomitic surface that comprises applying a photocatalytic fluid that comprises a metal oxide catalyst together with a metal dopant acting as an upconversion luminescence agent to the fomitic surface, and exposing said surface to a laser to form a coating upon the fomitic surface.

The fluid may be a sol-gel, or slurry of antibacterial materials in an aqueous carrier vehicle, wherein the antibacterial materials comprise a metal oxide catalyst together with a metal dopant acting as an upconversion luminescence agent.

The metal oxide may be a titanium oxide, and the metal dopant may comprise at least one of a transition metal, a rare earth, or heavy metal.

The fluid may also comprise silver in a nanoparticle or salt form.

According to a still further aspect of the invention, there is provided a composition for use in treating a fomitic surface, the said composition being capable of rendering said surface anti-bacterial under optical stimulation, and comprising at least one part titanium dioxide, and at least one part rare earth dopant, and presented for delivery as a sol-gel fluid that contains acidic components.

The sol-gel fluid may comprise at least one strong acid and at least one weak acid. The strong acid may be nitric acid, and the weak acid may be glacial acetic acid.

The antibacterial effect of the composition may be enhanced by including silver in an antimicrobially effective form. The silver may be provided in nanoparticle or salt form.

The composition may include a surface active agent or vehicle, to improve flow characteristics, such as a solvent, dispersant, extender or diluent to promote full coverage of a surface to be treated. A poly(ethylene glycol) (PEG), also known as poly(ethylene oxide) (PEO) or polyoxyethylene (POE), may be suitable for use in the surface treatment material.

According to yet another aspect of the invention, there is provided a method for preparing an anti-bacterial surface which continuously auto-disinfects when exposed to optical stimulation, said method comprising,

i) preparing an antimicrobial fluid comprising a photocatalytic component and an upconversion metallic component in a sol-gel composition,
ii) coating a fomitic surface on a substrate with said antibacterial fluid, and
iii) fixing the fluid coating without exposing the bulk of said substrate to heat wherein, the fixing step comprises exposing the fluid coating to a directed beam light source.

The method may be conducted such that the coating and fixing steps are carried out in close succession by use of apparatus including both a coating device and a directed beam light source.

The antibacterial fluid comprising a photocatalytic composition may be responsive to stimulation by wavelengths in the range of 350 to 790 nm.

Preferably, the photocatalytic component used in the aforesaid method comprises titanium dioxide, and the upconversion agent comprises a lanthanoid, optionally more than one lanthanide. A transition metal may be included in the composition.

The directed beam light source may be a laser, or other source capable of directing energy sufficient to perform an annealing function to a selected target zone, without imparting significant thermal effects upon the bulk material beneath a target surface.

An example of a suitable laser system is as follows. A laser emission at 248 nm, with narrow pulses of say around 25 nsecs may be satisfactory. Control systems can be used to regulate the power output of the laser from 0 to 12.5 W. This is achievable by voltage control (from 20 to 25 kV), and/or repetition rate control (from 0 to 50 Hz).

Any other method of applying sufficient heat to anneal the coating to the fomitic surface below, without heat-degrading the surface would be acceptable, but currently use of a laser is considered a convenient method for the purpose of any aspect of this invention.

Such a treatment process may thereby form a coating that can be optically stimulated using visible, or visible UV light, from a controlled source or natural daylight, to inhibit the proliferation of bacteria, and preferably thereby suppress infections arising from pathogens. Where the coating fluid is modified to include silver, this augments the activity of the antibacterial components, and permits a more general broad spectrum antimicrobial effect, as well as enhancing the activity of the antibacterial components.

An advantage of this aspect is that in contrast to typical prior art coatings comprising titanium oxide (titania) which require baking in a furnace, and consequential bulk heating of any coated substrate, the present invention avoids high temperatures affecting the bulk of the coated substrate by selectively treating the surface to achieve annealing and thereby fixing of the coating to the substrate.

In one embodiment of the present invention, a fomitic surface is uniformly coated with a photocatalytic composition responsive to wavelengths in the range of 350 to 790 nm comprising at least one photocatalyst and at least one dopant which may be an upconversion agent. The composition may be applied by spraying. The composition may be formulated as an aerosol. Other application methods suited to deposition of sol-gel fluids are suitable, e.g. dip-coating.

More than one application step may be adopted, e.g. successive dip-coatings, dip-coating followed by spraying etc.

Preferably, the composition comprises a fluid exhibiting antibacterial activity when stimulated by light, preferably natural daylight.

The antibacterial activity may be effected by a titanium oxide photo-catalytic reaction. The titanium oxide may be titanium dioxide.

The composition may include an oxide of another metal, which may be a photocatalyst, or photocatalyst precursor.

The photocatalyst precursor may be an organometallic compound such as an alkoxide of titanium(IV).

The dopant may be an electropositive trivalent metal.

The dopant may comprise a lanthanoid element.

The dopant may be a rare earth element. The rare earth element used may be presented for use in preparing the composition as a salt, preferably a water-soluble acid salt e.g. chloride or nitrate salts, the latter being preferred.

The dopant preferably acts to shift photocatalytic activity towards luminescence through stimulation using light in the “visible” range.

In another embodiment of the present invention, an antimicrobial surface may be prepared by multi-doping the coating with more than one lanthanide as this can cause an energy transfer between the lanthanides which can then enhance the titanium dioxide efficiency. This is based on the absorption wavelengths of the lanthanides in different areas of the electromagnetic spectrum which could allow a greater spread of activation wavelengths to cause the photocatalytic activity.

In another embodiment of the present invention, an antimicrobial surface may be prepared by coating a fomitic surface with an antimicrobial fluid using the sol-gel method, wherein the fixing step comprises a low or zero heat fixing method.

Preferably, the fixing step comprises a system wherein the surface to be treated is subjected to temperatures which do not significantly alter its bulk properties.

Preferably the fixing process comprises exposure to a laser beam.

The coating of the fomitic surface may be carried out in situ.

The coating of the fomitic surface may be carried out prior to its incorporation into a finished construct to provide a prefabricated auto-antimicrobial activity product,

wherein the antimicrobial activity is achieved by optical stimulation, e.g. simple exposure to light of an appropriate wavelength.

In another embodiment of the invention, the coating may comprise a first coating containing a lanthanide dopant which causes a visible fluorescence when exposed to UV light, and the addition thereto of a second coating which has a higher photocatalytic activity. This would enable an easy way to determine whether the coating was covering the whole area by a visual test, wherein fluorescence is used to evaluate the extent and integrity of the coating. An example of a suitable lanthanide dopant is samarium, although others such as europium could also be used.

In another embodiment of the invention, the coating may contain some larger particulates to provide an antislip property.

### BRIEF DESCRIPTION OF THE DRAWINGS

FIG. 1 shows the absorption spectra of a test sample coating demonstrating red spectral shift when doped with rare earth nitrates;

FIG. 2a shows assessment of the antibacterial activity of UV-illuminated (6×8 W UV arc lamp from a distance of 10 cm) 1 g/L TiO₂ slurries against ˜1×10⁶ colony forming units per millilitre (cfu/mL) S. aureus NCTC 6571 suspended in sterile distilled water at room temperature (about 21° C.);

FIG. 2b shows assessment of the antibacterial activity of UV-illuminated (6×8 W UV arc lamp from a distance of 10 cm) 1 g/L TiO₂ slurries against ˜1×10⁶ cfu/mL E. coli NCTC 12241 suspended in sterile aqueous 0.9% (w/v) NaCl at room temperature (about 21° C.);

FIG. 3a shows assessment of the antibacterial activity of UV alone (UV illuminated uncoated slides) from a distance of 15 cm using a 6×8 W UV arc lamp against 300 μL drops of ˜1×10⁶ cfu/mL S. aureus NCTC 6571 at room temperature (about 21° C.) using the humidity chamber method;

FIG. 3b shows assessment of the antibacterial activity of TiO₂ and Nd(NO₃)₃ (SG20″) coatings furnace-annealed onto glass slides, when UV illuminated from a distance of 15 cm using a 6×8 W UV arc lamp against 300 μL drops of ˜1×10⁶ cfu/mL S. aureus NCTC 6571 at room temperature (about 21° C.) using the humidity chamber method;

FIG. 4a shows assessment of the antibacterial activity of UV alone (UV-illuminated uncoated slides from a distance of 15 cm using a 6×8 W UV arc lamp against 300 μL drops of ˜1×10⁴ cfu/mL S. aureus NCTC 6571 at room temperature (about 21° C.) using the humidity chamber method;

FIG. 4b shows assessment of the antibacterial activity of TiO₂ and Nd(NO₃)₃ (SG20′) coatings with added polyethylene glycol furnace-annealed onto glass slides, when UV-illuminated from a distance of 15 cm using a 6×8 W UV arc lamp against 300 μL drops of ˜1×10⁴ cfu/mL S. aureus NCTC 6571 at room temperature (about 21° C.) using the humidity chamber method;

FIG. 4c shows assessment of the antibacterial activity of TiO₂ and Nd(NO₃)₃ (SG20′) coatings with addition of polyethylene glycol furnace-annealed onto glass slides, when UV illuminated from a distance of 15 cm using a 6×8 W UV arc lamp against 300 μL drops of ˜1×10⁶ cfu/mL S. aureus NCTC 6571 at room temperature (about 21° C.) using the humidity chamber method;

FIG. 4d shows assessment of the antibacterial activity of TiO₂ and Nd(NO₃)₃ (SG20′) coatings with addition of polyethylene glycol and AgNO₃ furnace-annealed onto glass slides, when UV illuminated from a distance of 15 cm using a 6×8 W UV arc lamp against 300 μL drops of ˜1×10⁶ cfu/mL S. aureus NCTC 6571 at room temperature (about 21° C.) using the humidity chamber method

FIG. 5a shows assessment of the antibacterial activity of UV alone (UV-illuminated uncoated slides) from a distance of 15 cm using a 6×8 W UV arc lamp against 300 μL drops of ˜1×10⁴ cfu/mL S. aureus NCTC 6571 at a temperature of 10° C. using the humidity chamber method;

FIG. 5b shows assessment of the antibacterial activity of TiO₂ and NdNO₃ (SG20) and PEG coatings furnace-annealed onto glass slides, when UV-illuminated from a distance of 15 cm using a 6×8 W UV arc lamp against 300 drops of ˜1×10⁴ cfu/mL S. aureus NCTC 6571 at a temperature of 10° C. using the humidity chamber method;

FIG. 6 shows the effect of silver doping alone to a titania base coating by reference to breakdown of methylene blue in the dark, and under UV illumination;

FIG. 7a shows assessment of the antibacterial activity of UV alone (UV-illuminated uncoated steel slides) from a distance of 15 cm using a 6×8 W UV arc lamp against 300 μL drops of ˜1×10⁴ cfu/mL S. aureus NCTC 6571 at a temperature of 10° C. using the humidity chamber method.

FIG. 7b shows assessment of the antibacterial activity of TiO₂, NdNO₃ and PEG coatings laser-annealed to a steel slide, when UV illuminated from a distance of 15 cm using a 6×8 W UV arc lamp against 300 μL drops of ˜1×10⁴ cfu/mL S. aureus NCTC 6571 at a temperature of 10° C. using the humidity chamber method;

FIG. 8a shows antibacterial effects of selected coatings as a percentage of methylene blue absorption after irradiation under a 500 W UV lamp;

FIG. 8b shows antibacterial effects of selected coatings as a percentage of methylene blue absorption after irradiation under a 500 W visible light lamp;

FIG. 8c shows antibacterial effects of selected coatings as a final c/c₀ value of methylene blue after irradiation under a 500 W UV lamp, (C=concentration after time, and Co=concentration at time 0);

FIG. 8d shows antibacterial effects of selected coatings as a final c/c₀ value of methylene blue after irradiation under a 500 W visible light lamp, (C=concentration after time, and Co=concentration at time 0);

FIG. 9a shows SEM image of a coating of the invention applied to a substrate prior to annealing (1000× magnification) revealing wide cracks and pits; and

FIG. 9b shows SEM image of a coating of the invention applied to a substrate after annealing by laser irradiation (1000× magnification) revealing narrow cracks and significant reduction in pits.

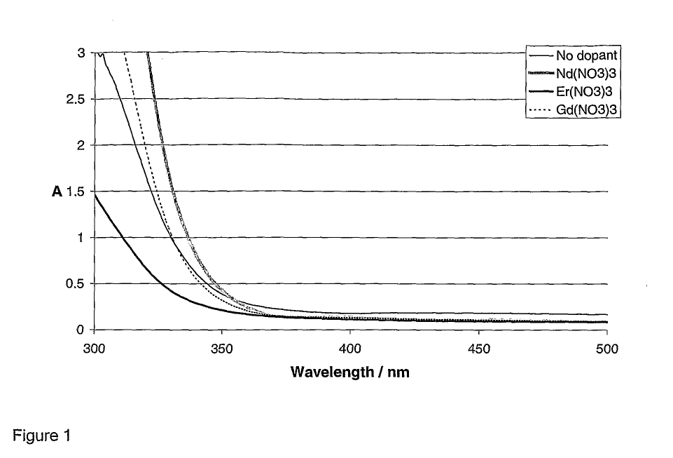

### DETAILED DESCRIPTION OF MODES FOR PERFORMANCE OF THE INVENTION

The invention will now be further described by way of the following examples.

### Example 1

In one embodiment, a steel or PVC surface for preparing food is coated with a composition of the present invention to render it capable of auto-oxidising organic matter when exposed to light, and therefore exhibiting anti-microbial properties. The surface, which may be a table or counter top is manufactured according to standard practice in the art. However, before fixing the table top to the rest of the table structure, it is coated with a composition of the present invention, said coating then being fixed, using a directed beam of light of sufficient energy to achieve annealing of the coating, e.g. by use of a laser to minimise thermal penetration into the coated surface. Once coated, the table top is then affixed to the rest of the table structure, which may then be used for food preparation with a reduced or obviated need for cleaning with disinfectant solutions.

In an alternative embodiment, the coating of the previous embodiment is applied post-installation to fitted surfaces such as kitchen worktops. This retro-treatment is achievable by spray coating followed by fixing by means of a controllable directed optical source of appropriate wavelength, such as a laser system. This option may be used to retro-treat previously installed surfaces in-situ, making it applicable for fixed furnishings and appliances.

### Example 2

A photocatalytic composition suitable for forming an auto-antibacterial coating composition is prepared as follows.

Rare earth (lanthanoid) salts and an organotitanate were introduced to a solvent fluid to form a coating composition fluid by a sol-gel method familiar to those in the field. Preparation of sol-gel materials incorporating photocatalytic components, especially titania film photocatalysts, is disclosed for example in Photochem. Photobiol Sci, 2003, 2, 591-596, Mills A. et al, whereas, rare earth doped titania nanoparticles are discussed in Journal of Catalysis 207, 151-157 (2002), Xu et al, both of which are incorporated herein by reference.

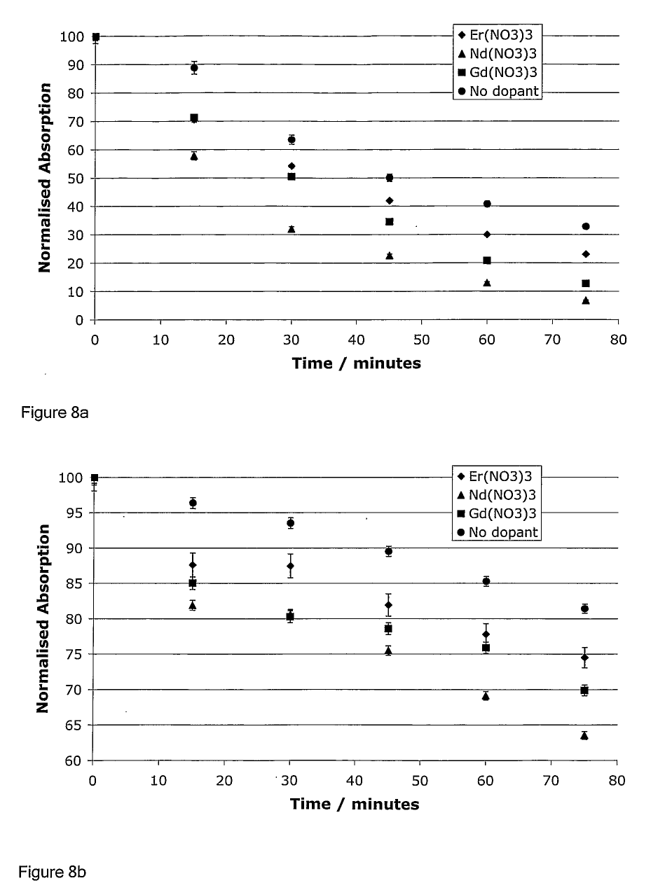

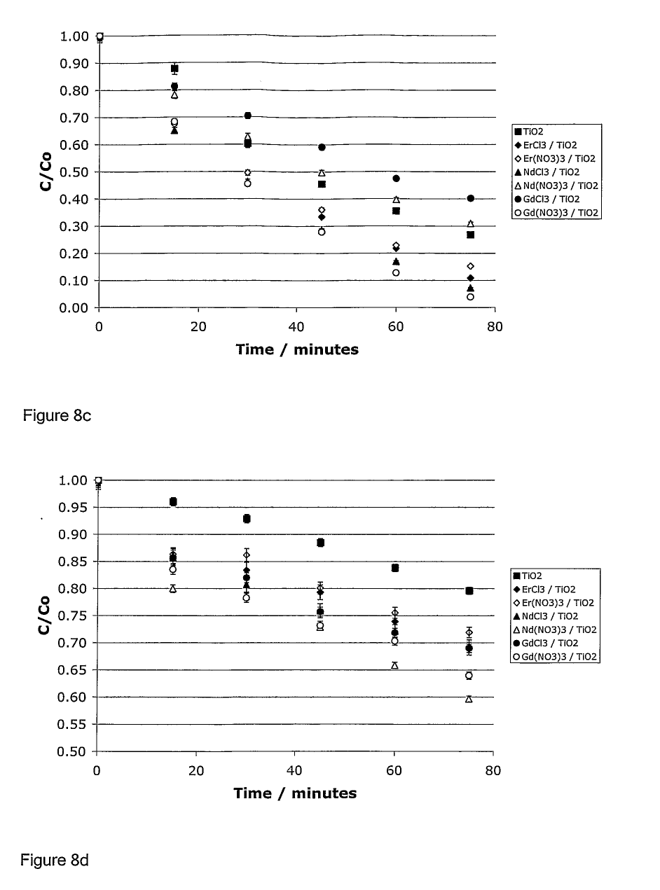

Generally, titanium (IV) isopropoxide, nitric acid and acetic acid were utilised to provide a base photocatalytic composition (Photo-Cat). Modification thereof for the purposes of the invention was carried out by including rare earth chloride and nitrate salts. Herein, evaluation of ErCl₃, Er(NO₃)₃ NdCl₃, Nd(NO₃)₃, GdCl₃ and Gd(NO₃)₃ is considered, with Nd(NO₃)₃ demonstrating good results (FIGS. 8c and 8d).

The following precursors, in the tables 1 and 2 below, were found to be particularly efficacious:

### Procedure:

0.3 g of the lanthanide salt was introduced to 120 mL of 0.1 mol L⁻¹ nitric acid and stirred sufficiently to achieve dissolution. To this a solution containing 4.43 mL glacial acetic acid and 20 mL of titanium (IV) isopropoxide was then added slowly, under stirring. This solution was then placed in a water bath at 80° C. and held at that temperature for 8 hours. The resulting opaque solution was then filtered through a 0.45 μm filter to remove any aggregated particles. The glass slides were then dip-coated and annealed in a furnace at 450° C. for 30 minutes.

TABLE 1
Final percentage of methylene blue absorption after 75 minutes
irradiation under a 500 W UV lamp

| Coating | Sol-gel | Sol-gel |
|---|---|---|
| formulation basis | (Photo-cat) | (Mod-Photo-Cat) |
| TiO_{2 (SG3)} | 32.89 | |
| ErCl₃/TiO_{2 (SG10)} | | 18.67 |
| Er(NO₃)₃/TiO_{2 (SG22)} | | 23.09 |
| NdCl₃/TiO_{2 (SG9B)} | | 16.46 |
| Nd(NO₃)₃/TiO_{2 (SG20)} | | 6.73 |
| GdCl₃/TiO_{2 (SG4)} | | 45.35 |
| Gd(NO₃)₃/TiO_{2 (SG21)} | | 12.78 |

TABLE 2
Final percentage of methylene blue absorption after 75 minutes
irradiation under a 500 W visible light lamp

| Coating | Sol-gel | Sol-gel |
|---|---|---|
| formulation basis | (Photo-cat) | (Mod-Photo-Cat) |
| TiO_{2 (SG3)} | 81.44 | |
| ErCl₃/TiO_{2 (SG10)} | | 71.59 |
| Er(NO₃)₃/TiO₂ | | 74.52 |
| NdCl₃/TiO_{2 (SG9B)} | | 73.06 |
| Nd(NO₃)₃/TiO_{2 (SG20)} | | 63.55 |
| GdCl₃/TiO_{2 (SG4)} | | 71.63 |
| Gd(NO₃)₃/TiO_{2 (SG21)} | | 69.91 |

The relative values of the precursors may be altered to change the properties of the coating.

The coating may be made into a paste by concentrating down the solution and adding polyethylene glycol, depending on the deposition technique chosen.

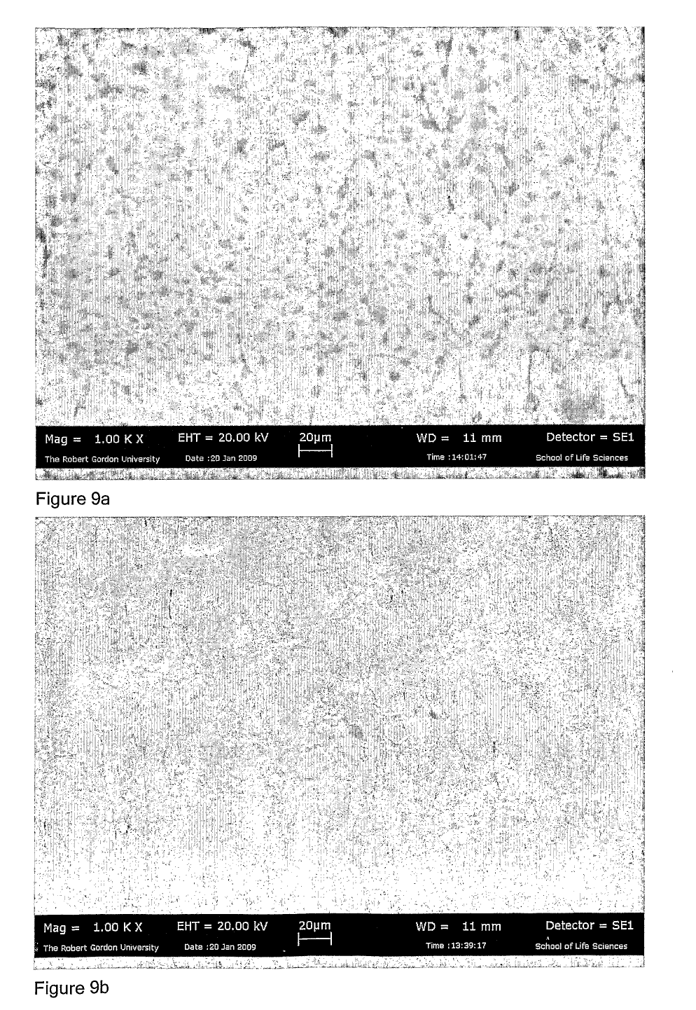

In a preferred embodiment, the sol-gel, slurry or paste photocatalytic coatings are applied to a stainless steel surface and exposed to UV laser pulses, wherein the laser emission was at 248 nm with narrow pulses of around 25 nanoseconds. SEM analysis was conducted upon Nd-doped TiO₂ samples including polyethylene glycol as a thickener. These are presented in the micrographs shown in FIGS. 9a and 9b, where the effect of the surface treatment by laser annealing to reduce cracks and pit formation is evident.

An antimicrobial coating exhibiting antibacterial activity even in the dark is available by doping a coating composition as above with a silver salt such as silver nitrate.

In order to demonstrate the effect of silver nitrate, a glass slide coated with a composition containing TiO₂, PEG and AgNO₃ and furnace annealed and a glass slide untreated were protected from illumination, and 300 μL drops of ˜1×10³ cfu/mL S. aureus applied. After six hours in the dark, it was determined that uncoated slides showed a decrease in viability of about 1.2-fold, whereas the coated slides showed a decrease in viability of about 1.8-fold. This shows that addition of silver has beneficial effects in the coatings even without photocatalysis effects of the TiO₂.

### Example 3

4.65 g (4.43 ml) of glacial acetic acid was added to 20 ml of titanium isopropoxide. 0.4132 g of Silver nitrate was then transferred into 120 ml of 0.1 mol 1⁻¹ nitric acid. The nitric acid was slowly added to the glacial acetic acid solution before heating the mixture at 80° C. for 8 hours in a water bath. The resulting opaque solution was then filtered through a 0.45 μm filter to remove any aggregated particles. The sol was then evaporated down at 95° C. for about 45 minutes until half of the volume was removed. To the concentrated sol, 9.8 g of crushed polyethylene glycol 6000 were added. The mixture was heated to 70° C. and stirred for an hour. The glass slides were then dip coated. Optionally the dip coating step can be repeated to build up the coating thickness.

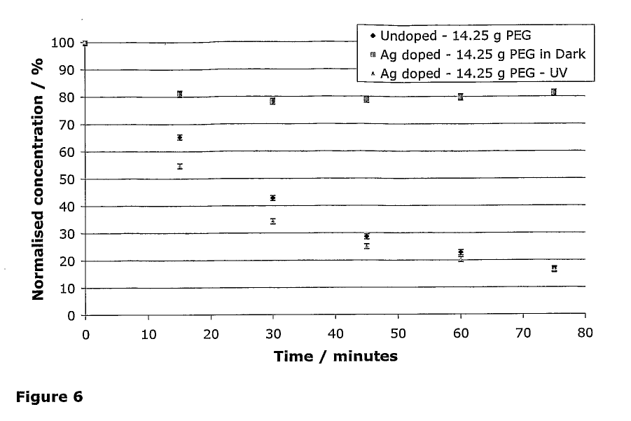

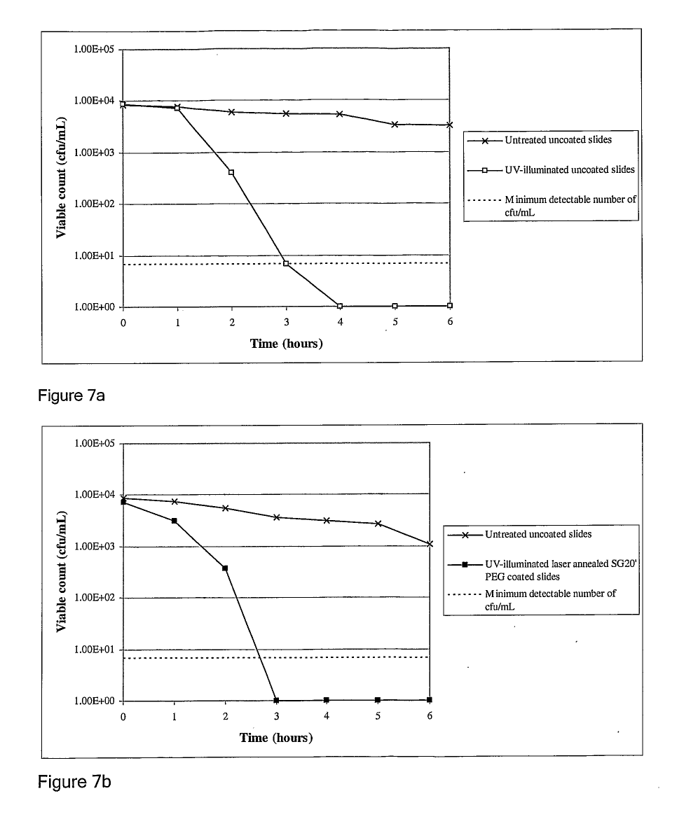

Initial results are shown in FIG. 6 comparing the effect of the addition of silver to non-rare earth-doped formulations. A dark control was also carried out to compare the breakdown of methylene blue without UV light.

### Example 4

Sample coating compositions prepared by a method following that of Example 2, were tested by application to various substrates for evaluation. The coatings were exposed to UV illumination or visible light illumination and the results are shown in FIGS. 8c, and 8d, and the value thereof is reported in the Tables 3 and 4 below.

TABLE 3
Final c/c₀ value of methylene blue after 75 minutes
irradiation under a 500 W UV lamp

| Coating | Sol-gel | Sol-gel |
|---|---|---|
| formulation basis | (Photo-cat) | (Mod-Photo-Cat) |
| TiO₂ | 0.27 | |
| ErCl₃/TiO₂ | | 0.11 |
| Er(NO₃)₃/TiO₂ | | 0.15 |
| NdCl₃/TiO₂ | | 0.07 |
| Nd(NO₃)₃/TiO₂ | | 0.31 |
| GdCl₃/TiO₂ | | 0.40 |
| Gd(NO₃)₃/TiO₂ | | 0.04 |

TABLE 4
Final c/c₀ value of methylene blue after 75 minutes
irradiation under a 500 W visible lamp

| | Sol-gel | Sol-gel |
|---|---|---|
| Coating formulation basis | (Photo-cat) | (Mod-Photo-Cat) |
| TiO₂ | 0.80 | |
| ErCl₃/TiO₂ | | 0.70 |
| Er(NO₃)₃/TiO₂ | | 0.72 |
| NdCl₃/TiO₂ | | 0.69 |
| Nd(NO₃)₃/TiO₂ | | 0.60 |
| GdCl₃/TiO₂ | | 0.69 |
| Gd(NO₃)₃/TiO₂ | | 0.64 |

The above data indicate that although certain lanthanide (lanthanoid) metals can enhance the photocatalytic activity under UV illumination, a larger change can be observed when illuminated under visible light. Table 4 indicates all of the doped formulations improved the degradation of methylene blue over the base formulation.

### Example 5

Preliminary experiments to evaluate the antibacterial properties of UV-illuminated TiO₂ were conducted using two model species of bacteria. It was proposed that bacterial cell killing would occur more rapidly under photocatalysis (i.e. UV and

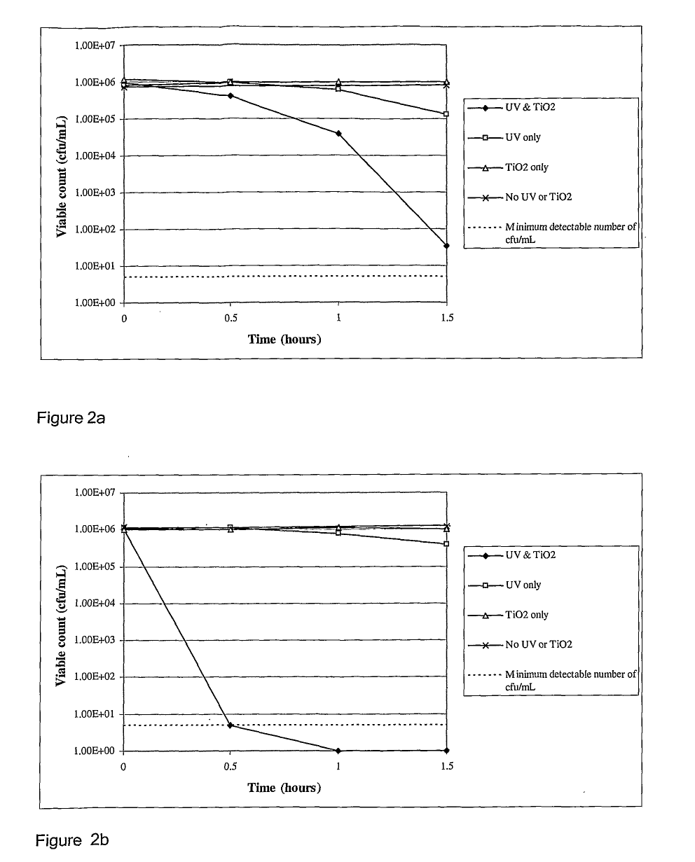

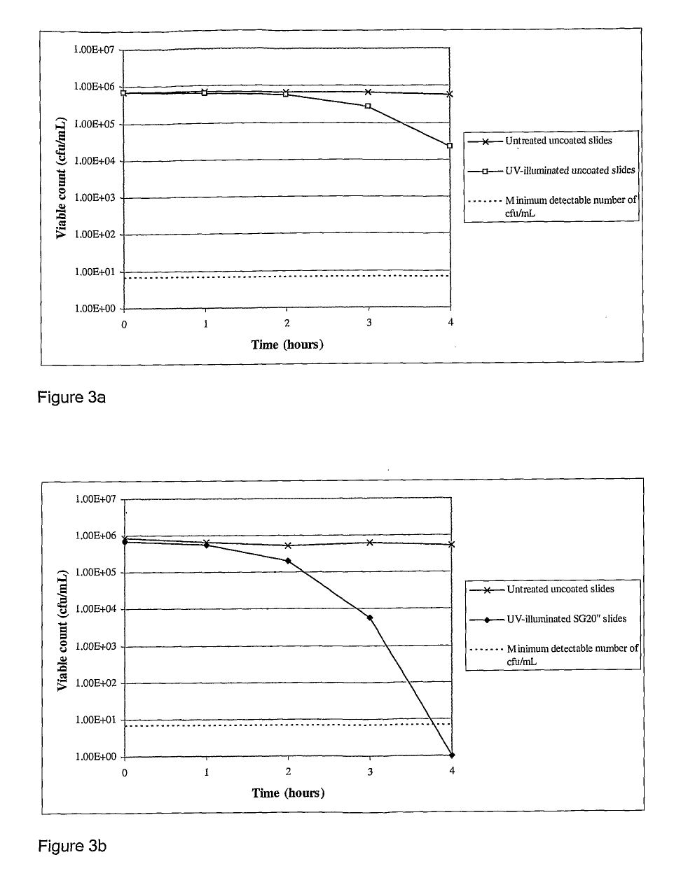

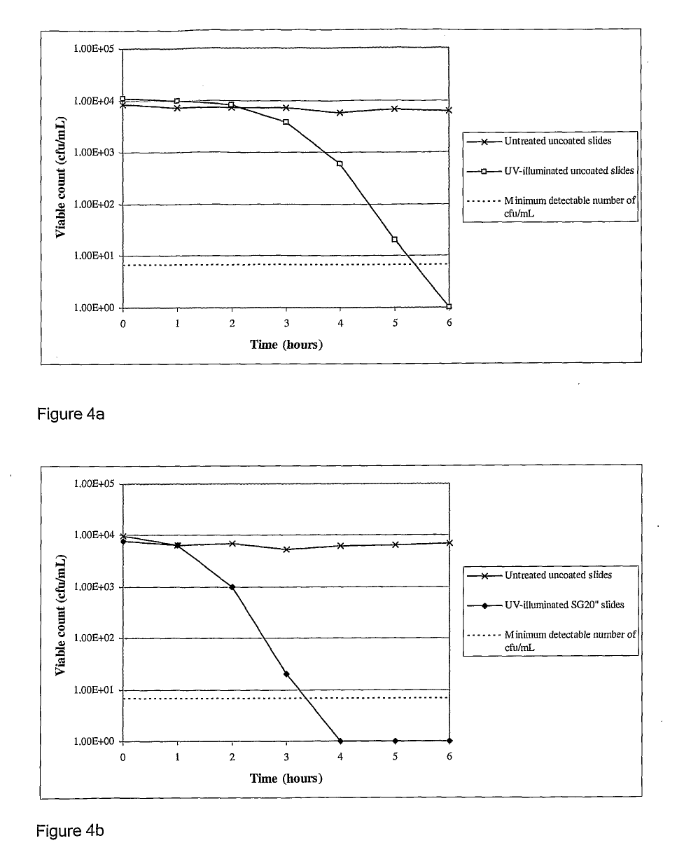

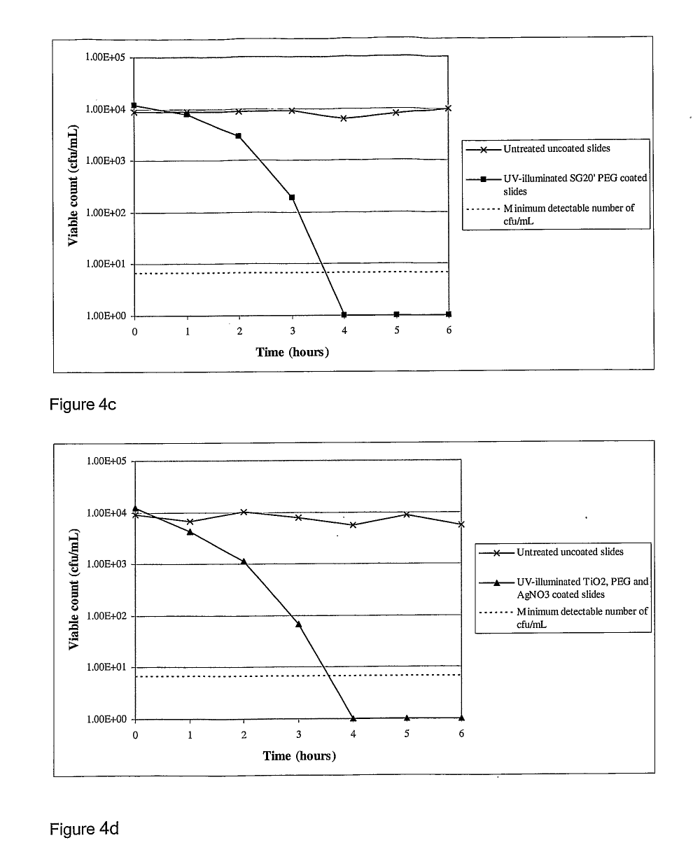

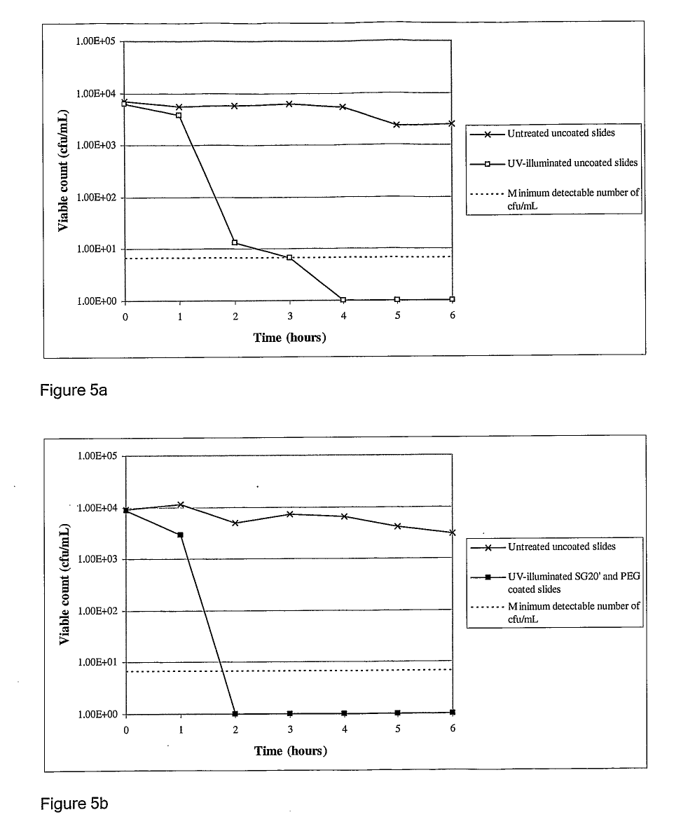

TiO₂) than by photolysis (UV alone). This was demonstrated in the current project at room temperature (21° C.) using a 48 W UV arc lamp, 1 g/L TiO₂ slurries, the Gram positive bacterium Staphylococcus aureus (FIG. 2a) and the Gram negative bacterium Escherichia coli (FIG. 2b).

Following the initial findings, research moved on to examine the antibacterial activity of different formulations of TiO₂ coating which had been furnace annealed onto glass slides. Batch reactor experiments with undoped SG3, NdCl₃-doped SG9B and ErCl₃-doped SG10 formulations illuminated with the 48 W UV arc lamp indicated that they all have antibacterial activity, even when tested against large volumes and high cell densities of bacteria. Degradation experiments with the indicator compound methylene blue showed undoped base TiO₂ coating SG3′ to be the least photocatalytically active and Nd(NO₃)-3-doped TiO₂SG20″ to be the most photocatalytically active formulation prepared to date. Data generated confirmed that both of these formulations have antibacterial activity when illuminated with the 48 W UV arc lamp, but no difference in the level of activity was detected.

Various adjustments and reconfigurations are possible to the illustrated embodiment as described above within the scope of the invention as will be apparent to those skilled in the art.

1. A surface treatment material for a fomitic surface that comprises a photocatalytic component in an amount effective to provide antibacterial effects under optical stimulation, wherein the photocatalytic component comprises a metal oxide catalyst together with a metal dopant acting as an upconversion luminescence agent.

2. A surface treatment material as claimed in claim 1, wherein the metal oxide is a titanium oxide, and the metal dopant comprises at least one of a transition metal, a rare earth, or heavy metal.

3. A surface treatment material as claimed in claim 2, wherein the metal dopant is a metal salt, metal complex or metal compound conferring the desired upconversion luminescence properties in the prepared photocatalytic component.

4. A surface treatment material as claimed in claim 1, comprising silver in a form suitable to perform an antimicrobial function.

5. A surface treatment material as claimed in claim 4, wherein silver is present as a nanoparticle or salt.

6. A surface treatment material as claimed in claim 1 comprising a fluid coating composition adapted to be annealed to a surface, using a directed beam of light for fixing the composition as an annealed coating.

7. A surface treatment material as claimed in claim 1 comprising a polyethylene glycol.

8. A treatment process for a fomitic surface that comprises applying a photocatalytic fluid that comprises a metal oxide catalyst together with a metal dopant acting as an upconversion luminescence agent, to the fomitic surface, and exposing said surface to a directed beam of light for fixing the fluid to form a coating upon the fomitic surface.

9. A composition for use in treating a fomitic surface, said composition being capable of rendering said surface anti-bacterial under optical stimulation, and comprising at least one part titanium dioxide, and at least one part rare earth dopant, and presented for delivery as a sol-gel fluid that contains acidic components.

10. A composition as claimed in claim 9, wherein the acidic components comprise at least one strong acid and at least one weak acid.

11. A composition as claimed in claim 9 comprising silver in an antimicrobially-effective form.

12. A composition as claimed in claim 1 comprising a polyethylene glycol.

13. A method for preparing an anti-bacterial surface which continuously auto-disinfects when exposed to optical stimulation, said method comprising,
i) preparing an antibacterial fluid comprising a photocatalytic component and an upconversion metallic component in a sol-gel composition;
ii) coating a fomitic surface on a substrate with said antibacterial fluid; and
iii) fixing the fluid coating without exposing the bulk of said substrate to heat wherein, the fixing step comprises exposing the fluid coating to a directed beam of light.

14. A method according to claim 13, wherein coating and irradiation steps are carried out in close succession by use of apparatus including both a coating device and a directed beam light source.

15. A method according to claim 13, wherein the antibacterial fluid comprising a photocatalytic composition is one that is responsive to wavelengths in the range of 350 to 790 nm.

16. A method according to claim 13, wherein the photocatalytic component comprises titanium dioxide, and the upconversion agent comprises a lanthanoid.

17. A method according to claim 16, wherein the photocatalytic component comprises more than one lanthanide.

18. A method according to claim 16 comprising forming a first coating containing a lanthanide dopant which causes a visible fluorescence when exposed to UV light, and the addition thereto of a second coating which has a higher photocatalytic activity.

19. A method according to claim 18, wherein the coating comprises samarium.

20. A method according to claim 13, wherein the coating comprises at least one antibacterial component selected from the group consisting of ErCl₃/TiO₂, Er(NO₃)₃/TiO₂, NdCl₃/TiO₂, Nd(NO₃)₃/TiO₂, GdCl₃/TiO₂, Gd(NO₃)₃/TiO₂.
